(19) United States
(12) Patent Application Publication
(10) Pub. No.: US 2019/0087823 A1
(43) Pub. Date: Mar. 21, 2019

(54) CASHLESS TRANSACTION PROCESSING METHODS AND APPARATUS

(71) Applicant: Mastercard International Incorporated, Purchase, NY (US)

(72) Inventors: Keyur Patel, Vadodara (IN); PiyushKumar Mistry, Navsari (IN); Rahul Ojha, Ratlam (IN); Hiren Patel, Ahmedabad (IN)

(21) Appl. No.: 16/048,670

(22) Filed: Jul. 30, 2018

(30) Foreign Application Priority Data
Sep. 20, 2017 (IN) 201741033395

(51) Int. Cl. G06Q 20/40; G06Q 20/34

(52) U.S. Cl. CPC G06Q 20/4093; G06Q 20/347

(57) ABSTRACT

A cashless transaction processing method is disclosed. The method comprises: receiving, in an issuer server, a transaction token request from a customer device, the transaction token request comprising an indication of a payment card account associated with a customer; providing a token to the customer device in response to the transaction token request; storing an indication of the token on the issuer server; receiving, from an acquirer server, a transaction authorization request, the transaction authorization request comprising a token; authenticating the token received in the transaction authorization request against the stored token; and initiating a transaction for the transaction amount from the payment card account associated with the customer.

### CROSS-REFERENCE TO RELATED APPLICATION

This application is a U.S. National Stage filing under 35 U.S.C. § 119, based on and claiming benefits of and priority to Indian Patent Application No. 201741033395 filed on Sep. 20, 2017. The entire disclosure of the above application is incorporated herein by reference for all purposes.

### TECHNICAL FIELD AND BACKGROUND

The present disclosure relates to cashless payment transactions. In particular, it provides methods and systems to allow cashless payments to a merchant by a consumer.

In emerging economies such as India many merchants do not have sophisticated point of sale (POS) devices. This is one of the reasons why in such economies approximately 85% of transactions are made using cash. Many of these transactions are for relatively small amounts and therefore the provision of POS devices to merchants handling such transactions is low.

In order to increase the use of cashless payments in such circumstances there is a need to provide cashless payment methods and systems which do not require the use of sophisticated POS devices.

### SUMMARY

In general terms, the present disclosure proposes methods and systems for processing cashless transactions without the requirement for a sophisticated POS device. When a customer wishes to make a payment to a merchant, the customer requests a token from an issuing organization. In response to the request a token is provided to the customer. The customer then provides the token to the merchant. The merchant then provides the token to an acquirer bank which authenticates the token with the issuer. If the authentication is successful, the issuer transfers funds corresponding to the payment amount from a payment card account associated with the customer. Thus the transaction can be processed without the customer's payment card details being known by the merchant. Further, it is envisaged that the method may be implemented smart phone devices owned by the customer and merchant so there is no requirement for POS devices or near field communication (NFC) devices.

According to a first aspect of the present invention, there is provided a cashless transaction processing method. The method comprises: receiving, in an issuer server, a transaction token request from a customer device, the transaction token request comprising an indication of a payment card account associated with a customer; providing a token to the customer device in response to the transaction token request; storing an indication of the token on the issuer server; receiving, from an acquirer server, a transaction authorization request, the transaction authorization request comprising a token; authenticating the token received in the transaction authorization request against the stored token; and initiating a transaction for the transaction amount from the payment card account associated with the customer.

In an embodiment, the transaction token request further comprises an indication of a transaction amount.

In an embodiment, the token has an expiry time and the authenticating the token received in the transaction authorization request further comprises determining whether the transaction authorization request was received within the expiry time.

In an embodiment the method further comprises generating a passcode; and providing the passcode to the customer device, wherein the transaction authorization request further comprises an indication of a passcode; and wherein authenticating the token received in the transaction authorization request further comprises comparing the received passcode with the passcode provided to the customer device.

In an embodiment, the token comprises an issuer identifier portion which uniquely identifies an issuer organization associated with the issuer server. In an embodiment, the token comprises a random number portion.

According to a second aspect of the present invention, there is provided a data processing apparatus for processing cashless transactions. The data processing apparatus comprises: a computer processor; and a data storage device, the data storage device having a token authentication component and a transaction initiation component comprising non-transitory instructions operative by the processor to: receive a transaction token request from a customer device, the transaction token request comprising an indication of a payment card account associated with a customer; provide a token to the customer device in response to the transaction token request; store an indication of the token on the issuer server; receive, from an acquirer server, a transaction authorization request, the transaction authorization request comprising a token; authenticate the token received in the transaction authorization request against the stored token; and initiate a transaction for the transaction amount from the payment card account associated with the customer.

According to a yet further aspect, there is provided a non-transitory computer-readable medium. The computer-readable medium has stored thereon program instructions for causing at least one processor to perform operations of a method disclosed above.

### BRIEF DESCRIPTION OF THE DRAWINGS

Embodiments of the invention will now be described for the sake of non-limiting example only, with reference to the following drawings in which:

FIG. 1 is a block diagram of a data processing system according to an embodiment of the present invention;

FIG. 2 is a block diagram illustrating a technical architecture of an issuer server according to an embodiment of the present invention; and

FIG. 3 is a flowchart showing a method of processing a cashless transaction according to an embodiment of the present invention.

### DETAILED DESCRIPTION

As used herein, the term “payment card” refers to any suitable cashless payment device, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers. Each type of payment card can be used as a method of payment for performing a transaction.

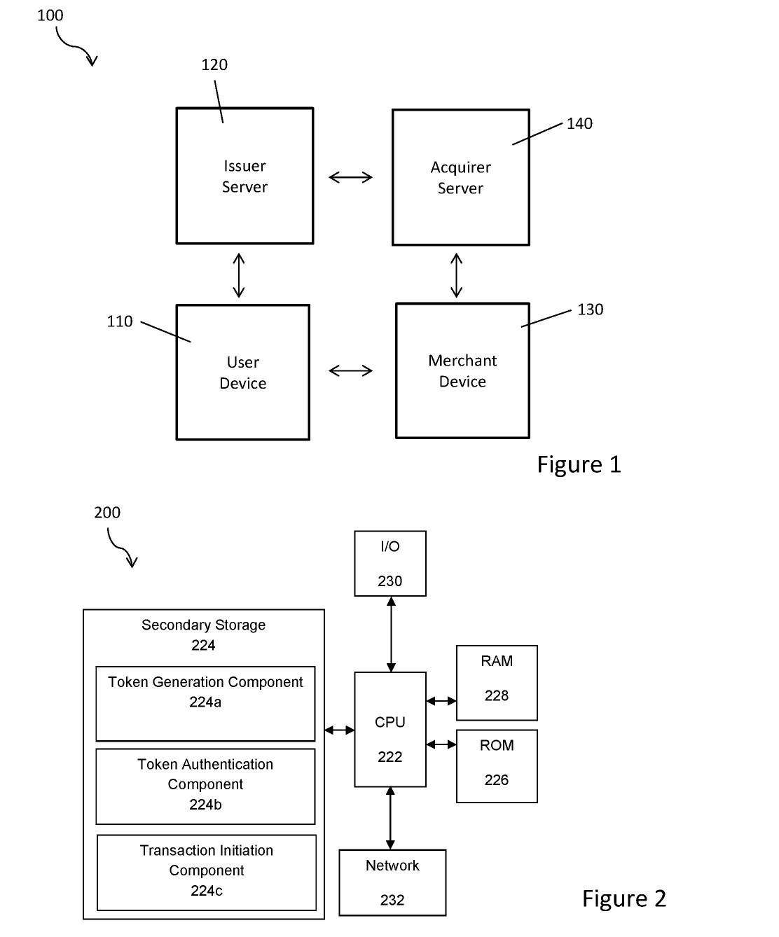

FIG. 1 is a block diagram showing a data processing system according to an embodiment of the present invention. The data processing system processes cashless transactions between a customer and a merchant. The data processing system comprises a user device 110 associated with the customer; an issuer server 120; a merchant device 130 associated with the merchant; and an acquirer server 140.

The user device 110 is a mobile computing device such as a smart phone, tablet device or laptop computer. The user device 110 is coupled to the issuer server 120 via a network such as a mobile telephone network or the internet. In some embodiments a communication channel between the user device 110 and the merchant device 130 is used to transmit a token between the user device 110 and the merchant device 130. This communication channel may be a mobile telecommunications network and the communication may take place through short message service (SMS) or unstructured supplementary service data (USSD), or other electronic communication method. In other embodiments the customer and merchant may exchange information such as the token in person.

The issuer server 120 is a server associated with a financial institution is authorised by a payment network to issue payment card on behalf of customers to perform transactions over the payment network. The financial institution also provides funding of the transaction to the payment network for transactions that are approved.

As described in more detail below, the issuer server 120 operates to generate a token in response to a request from the user device 110. This token may be used by the customer to carry out a transaction with the merchant without the need to provide the merchant with the details of their payment card. In some embodiments, the token may be generated by a separate party from the issuer server 120, for example a token service provider.

The acquirer server 140 is a server associated with a financial institution with which the merchant has an account. The acquirer server 140 is communicatively coupled with merchant device 130 via a communication network. The acquirer server 140 may communicate with the merchant device via an application programming interface (API) or SMS or USSD.

The acquirer server 140 and the issuer server 120 are both connected via a payment network which routes transaction authorization requests. An example of a payment network is the payment network provided by MasterCard.

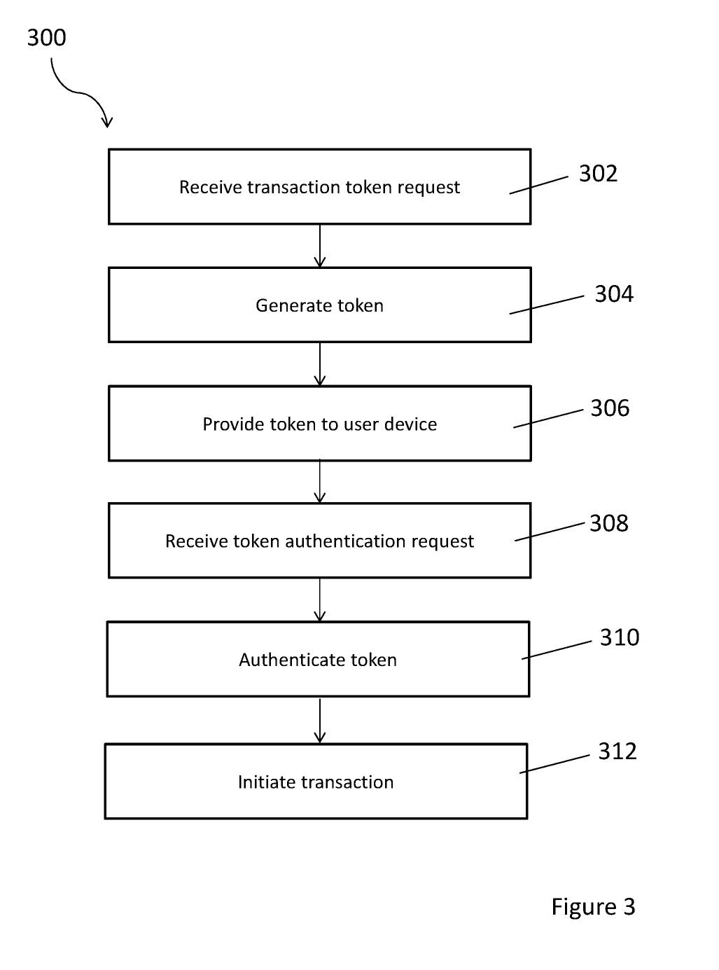

FIG. 2 is a block diagram showing a technical architecture 200 of the issuer server 120 for performing an exemplary method 300 as described below with reference to FIG. 3. Typically, the method 300 is implemented by a computer having a data-processing unit. The block diagram as shown FIG. 2 illustrates a technical architecture 200 of a computer which is suitable for implementing one or more embodiments herein.

The technical architecture 200 includes a processor 222 (which may be referred to as a central processor unit or CPU) that is in communication with memory devices including secondary storage 224 (such as disk drives), read only memory (ROM) 226, and random access memory (RAM) 228. The processor 222 may be implemented as one or more CPU chips. The technical architecture 200 may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution. In this embodiment, the secondary storage 224 has a token generation component 224a, a token authentication component 224b, and a transaction initiation component 224c comprising non-transitory instructions operative by the processor 222 to perform various operations of the method of the present disclosure. As depicted in FIG. 2, the components 224a-224c are distinct modules which perform respective functions implemented by the issuer server 200. It will be appreciated that the boundaries between these components are exemplary only, and that alternative embodiments may merge components or impose an alternative decomposition of functionality of components. For example, the components discussed herein may be decomposed into sub-components to be executed as multiple computer processes, and, optionally, on multiple computers. Moreover, alternative embodiments may combine multiple instances of a particular component or sub-components. It will also be appreciated that, while a software implementation of the components 224a-224c is described herein, these may alternatively be implemented as one or more hardware components (such as field-programmable gate array(s) or application-specific integrated circuit(s)) comprising circuitry which implements equivalent functionality to that implemented in software. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture 200 is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 200 to provide the functionality of a number of servers that is not directly bound to the number of computers in the technical architecture 200. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture 200, at least one of the CPU 222, the RAM 228, and the ROM 226 are changed, transforming the technical architecture 200 in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Various operations of an exemplary method 300 will now be described with reference to FIG. 3 in respect of processing a cashless transaction. It should be noted that enumeration of operations is for purposes of clarity and that the operations need not be performed in the order implied by the enumeration.

The method 300 begins when the customer wishes to make a transaction with the merchant. In order to facilitate the transaction, the customer, using the user device 110 submits a transaction token request to the issuer server 120. The communication between the user device 110 and the issuer may be facilitated by a wallet application running on the user device 110. The wallet application stores an indication of a payment card account associated with the user. To initiate the method, the user may open the wallet application on the user device 110. This may include the user entering a password, passcode or biometric data to authenticate themselves. The user may then enter an indication of the desired transaction amount and may select or confirm a payment card account to be used for the transaction.

In step 302, the issuer server 120 receives the transaction token request from the user device. The transaction token request comprises an indication of the payment card account of the customer. The transaction token request may also comprise an indication of a transaction amount for the transaction between the customer and the merchant.

In step 304, the token generation component 224a of the issuer server 120 generates a token. The token may comprise a tenant identifier portion that identifies the issuer and a random number portion that uniquely identifies the token. For example, the token may comprise a 3 digit tenant identifier portion and a 6 digit random number. The tenant identifier portion allows the token to be routed to the issuer server 120 by the payment network.

The issuer server 120 may store an indication of the token linked to details of the transaction such as the transaction amount and details of the payment card account associated with the customer. The token may be generated with a limited lifetime, for example the token may have to be used within 180 seconds of its creation. In an embodiment the expiry of the token is in the range 120 to 360 seconds.

In some embodiments, in addition to generating the token, the issuer server also generates a passcode, for example, a 4 or 6 digit number.

In step 306, the issuer server 120 provides the token to the user device 110. Step 306 may involve the issuer server 120 sending the token to the wallet application running on the user device. If a passcode was also generated, the passcode is also provided to the user device 120.

Once the user device 110 receives the token, and the passcode, the customer provides these to the merchant. In some embodiments, the user provides the token to the merchant in person. The token is a soft token, for example a string of characters. In some embodiments, the customer may provide the token to the merchant electronically, for example by sending a text message or SMS message including the token from the user device 110 to the merchant device 130. In some embodiments, the customer may provide the token to the merchant electronically and may provide the passcode to the merchant verbally.

Once the merchant has received the token and, if applicable, the passcode, the merchant device 130 sends the token to the acquirer server 140. The token, and if applicable the passcode, may be send to the acquirer server 140 via an API, SMS message, USSD or other data transfer protocol. The merchant device 130 may also send details of the transaction amount to the acquirer server 140.

Once the acquirer server 140 has received the token and the passcode, the acquirer server 140 generates a token authentication request. The token authentication request comprises the token and if applicable, the passcode. The token authentication request is sent by the acquirer server 140 to the issuer server 120 via a payment network. The payment network may use the token included in the token authentication request to route the token authentication request to the issuer server 120. The token may comprise a string to characters which the payment network uses to identify the issuer server 120 to route the token authentication request. In one embodiment, the token may include a dummy payment card number which is used by the payment network identify how to route the token authentication request. In step 308, the issuer server 120 receives the token authentication request from the acquirer server 140 via the payment network.

In step 310, the token authentication component 224b of the issuer server 120 authenticates the token received in the token authentication request. The authentication may comprise validating the received token against the stored token to check if the two tokens match. This check may include checking that each character in the string of characters making up the token matches the string of characters in the stored token. If a passcode was also provided to the user device 110, a passcode received as part of the token authentication request may also be compared with the passcode provided to the user device 110. As discussed above, in some embodiments, the token has a limited lifetime, in such embodiments, the authentication of the token may comprise determining whether the lifetime has expired.

In step 312, if the authentication in step 310 was successful, the transaction initiation component 224c of the issuer server 120 initiates a transaction from the payment card associated with the customer to an account associated with the merchant. In step 312, the acquirer may be provided with the payment card details in order to carry out the transaction.

The merchant 130 may have an account registered with the acquirer server 140. In some embodiments, the acquirer server 140 may use the payment card details received in step 312 to initiate a transaction for the transaction amount from the account associated with the customer which is identifiable using the payment card details and the account associated with the merchant.

In some embodiments, the token authentication request sent by the acquirer server 140 to the issuer server 120 comprises an indication of an account associated with the merchant, thus, the transaction from the account associated with the customer to the account associated with the merchant can be initiated by the issuer server 120.

Whilst the foregoing description has described exemplary embodiments, it will be understood by those skilled in the art that many variations of the embodiment can be made within the scope and spirit of the present invention.

1. A cashless transaction processing method comprising:
receiving, in an issuer server, a transaction token request from a customer device, the transaction token request comprising an indication of a payment card account associated with a customer;
providing a token to the customer device in response to the transaction token request;
storing an indication of the token on the issuer server;
receiving, from an acquirer server, a transaction authorization request, the transaction authorization request comprising a token;
authenticating the token received in the transaction authorization request against the stored token; and
initiating a transaction for the transaction amount from the payment card account associated with the customer.

2. A cashless transaction processing method according to claim 1, wherein the transaction token request further comprises an indication of a transaction amount.

3. A cashless transaction processing method according to claim 1, wherein the token has an expiry time and the authenticating the token received in the transaction authorization request further comprises determining whether the transaction authorization request was received within the expiry time.

4. A cashless transaction processing method according to claim 1, further comprising generating a passcode; and providing the passcode to the customer device, wherein the transaction authorization request further comprises an indication of a passcode; and wherein authenticating the token received in the transaction authorization request further comprises comparing the received passcode with the passcode provided to the customer device.

5. A cashless transaction processing method according to claim 1 wherein the token comprises an issuer identifier portion which uniquely identifies an issuer organization associated with the issuer server.

6. A cashless transaction processing method according to claim 1 wherein the token comprises a random number portion.

7. A data processing apparatus for processing cashless transactions, the data processing apparatus comprising:
a computer processor; and
a data storage device, the data storage device having a token authentication component and a transaction initiation component comprising non-transitory instructions operative by the processor to:
receive a transaction token request from a customer device, the transaction token request comprising an indication of a payment card account associated with a customer;
provide a token to the customer device in response to the transaction token request;
store an indication of the token on the issuer server;
receive, from an acquirer server, a transaction authorization request, the transaction authorization request comprising a token;
authenticate the token received in the transaction authorization request against the stored token; and
initiate a transaction for the transaction amount from the payment card account associated with the customer.

8. A data processing apparatus according to claim 7, wherein the transaction token request further comprises an indication of a transaction amount.

9. A data processing apparatus according to claim 7, wherein the token has an expiry time and the token authentication component comprises comprising non-transitory instructions operative by the processor to: authenticate the token received in the transaction authorization request by determining whether the transaction authorization request was received within the expiry time.

10. A data processing apparatus according to claim 7, the data storage device further comprising a token generation component comprising non-transitory instructions operative by the processor to generate the token.

11. A data processing apparatus according to claim 10, wherein the token generation component further comprises non-transitory instructions operative by the processor to: generate a passcode and, wherein the transaction authorization request further comprises an indication of a passcode; and wherein the token authentication component further comprises non-transitory instructions operative by the processor to: authenticate the token received in the transaction authorization request by comparing the received passcode with the passcode provided to the customer device.

12. A data processing apparatus according to claim 7, wherein the token comprises an issuer identifier portion which uniquely identifies an issuer organization associated with the issuer server.

13. A data processing apparatus according to claim 7, wherein the token comprises a random number portion.
